(19) United States
(12) Patent Application Publication
(10) Pub. No.: US 2026/0086980 A1
(43) Pub. Date: Mar. 26, 2026

(54) MULTI-DEVICE FILE STORAGE MANAGEMENT

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN)

(21) Appl. No.: 18/896,303

(22) Filed: Sep. 25, 2024

(51) Int. Cl. G06F 16/13; G06F 16/14; G06F 16/16

(52) U.S. Cl. CPC G06F 16/13; G06F 16/148; G06F 16/162

(57) ABSTRACT

A method provides techniques for multi-device file storage management that can prevent inadvertent deletion of a last copy of a file from a multi-device file storage environment. The method includes detecting, on an electronic device including a display, and a communications subsystem, a delete action for a file stored on the electronic device. The method further includes querying one or more second electronic devices within the multi-device environment to determine if a copy of the file resides on one of the one or more second electronic device. In response to determining that no copy of the file resides on any of the one or more second electronic devices, rendering and presenting a warning message on the display, the warning message indicating that no additional copies of the file exist.

### BACKGROUND

### 1. Technical Field

The present disclosure generally relates to electronic devices, and more specifically to electronic devices that support file storage.

### 2. Description of the Related Art

Modern electronic devices, such as computers, tablet computers, and smartphones, can store varies types of files. The files can include executable files, configuration files, system files, scripts, and others that are essential for a proper configuration and operation of an electronic device. Additionally, the files can include user data files (or documents), such as word/text documents, spreadsheets, presentation documents, and more. The user data files can also include media files, such as audio files, image files, and video files. The media files often contain information such as personal photos of family and friends, and so on. The various user data files are often important to a user and stored in one or more locations for later access by the user.

Efficiently and securely backing up data files is crucial for several reasons, ranging from ensuring data availability and integrity to protecting against data loss and security breaches. Users can inadvertently delete important files. Having backups of the files ensure that these files can be retrieved from another storage location, if necessary. Effective use of data backups is essential for protecting against data loss, ensuring data integrity and availability, and safeguarding against cyber threats.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to implement multi-device file storage management, according to one or more embodiments;

FIG. 2 is an example user interface rendered on an electronic device to provide multi-device file storage management, according to one or more embodiments;

FIG. 3A illustrates an example multi-device file storage management environment with a single copy of a file stored on a single first device within a grouping of multiple user devices sharing storage resources and available for individually storing copies of a file, according to one or more embodiments;

FIG. 3B illustrates the multi-device file storage management environment of FIG. 3A, following a complete deletion of the single copy of the file from the single first device, according to one or more embodiments;

FIG. 3C illustrates the multi-device file storage management environment of FIG. 3A in which the file selected for deletion from the single first device is transferred to and stored within a file-originating device within the multiple device grouping, according to one or more embodiments;

FIG. 3D illustrates an example of transferring a file to all other local devices within a multi-device file storage management environment, based on the initial conditions indicated in FIG. 3A, according to one or more embodiments;

FIG. 3E illustrates an example of transferring a file to a cloud storage system, according to one or more embodiments;

FIG. 3F illustrates an example of transferring a file to all other local devices within a multi-device file storage management environment and a cloud storage system, according to one or more embodiments;

FIG. 4 illustrates exemplary data structures used for multi-device file storage management, according to one or more embodiments;

FIG. 5 depicts a flowchart of a computer-implemented method for multi-device file storage management, according to one or more embodiments; and

FIG. 6 depicts a flowchart of a computer-implemented method for multi-device file storage management including cloud storage, according to one or more embodiments.

### DETAILED DESCRIPTION

According to aspects of the present disclosure, an electronic device, a method, and a computer program product provide techniques for backing up data in a multi-device file storage environment to ensure at least one copy of the data remains in the event of deletion/inaccessibility of the data on one device. In embodiments, multi-device file storage is used instead of, or in addition to, cloud storage. Although cloud storage offers numerous benefits, including scalability, accessibility, and data redundancy, there are also several disadvantages to using cloud storage. A primary disadvantage can be financial costs. Cloud storage often involves recurring monthly or annual fees, which can add up over time. Moreover, cloud storage costs can increase unpredictably based on usage, such as the addition of data transfer fees or additional charges for exceeding storage limits. Some cloud storage providers charge fees for data transfer out of their cloud storage, which can become substantial if large amounts of data are regularly moved. Another potential disadvantage of cloud storage is reliance on internet connectivity. Poor connectivity can hinder data access to/from cloud storage. Thus, relying solely on cloud storage for backup brings several potential disadvantages, including ongoing and variable costs, dependency on internet connectivity, security and privacy concerns, vendor lock-in, hidden fees, performance issues, compliance challenges, and data management complexities.

Accordingly, device users who own multiple devices with local storage often resort to locally storing their files on the local device storage, with one or more copies of the file shared with and stored on multiple user devices than can be interconnected for file transfer and redundant/backup storage within a multi-device environment/system. This multi-device environment/system mitigates the aforementioned disadvantages in use of cloud storage by implementing multi-device file storage management. The multi-device file storage management can facilitate backup, retrieval, and deletion of files in a multi-device system. The multi-device system can include multiple electronic devices that are interconnected via a local area network (LAN) and electronic devices connected via personal area network (PAN) and/or direct device-to-device connections, such as via Bluetooth. These interconnected devices may be referred to as local devices. Thus, with disclosed embodiments, the user can remain in full control of all the storage locations of a given file on the local devices. As an example, an image acquired on a smartphone can be backed up to a user's tablet computer, laptop computer, and/or desktop computer with the original image stored on the integrated storage or removable storage device of the smartphone, as the originating device. In cases where a particular local device is running low on available space, a file may be deleted from that local device, independent of the storage or deletion of the file on the other local devices. Accordingly, situations can occur where the file selected for deletion and subsequently deleted from a first local device was the only or last remaining copy of the file across the multiple local devices within the multi-device environment/system. In situations where the particular device is the only device within the multi-device system that includes the file, disclosed embodiments provide notification to the user of the file being a final copy across the multi-device environment and present one or more options for the user to move the file to one or more other devices within the multi-device system, thus preventing the inadvertent deletion of the last copy of the file across the multi-device environment.

One or more embodiments can include an electronic device including: at least one output device, including a display; a communications subsystem, comprising at least one wireless interface for communicatively connecting with at least one second electronic device; a memory having stored thereon a multi-device storage (MDS) module; and at least one processor communicatively coupled to the display, the communications subsystem, and the memory, the at least one processor executing program code of the MDS module, and is configured to cause the electronic device to: detect a delete action for a file stored on the electronic device; query each of the at least one second electronic device to determine if a copy of the file resides on the second electronic device; in response to determining that no copy of the file resides on any of the at least one second electronic device, render and present a warning message on the display, the warning message indicating that no additional copies of the file exist.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

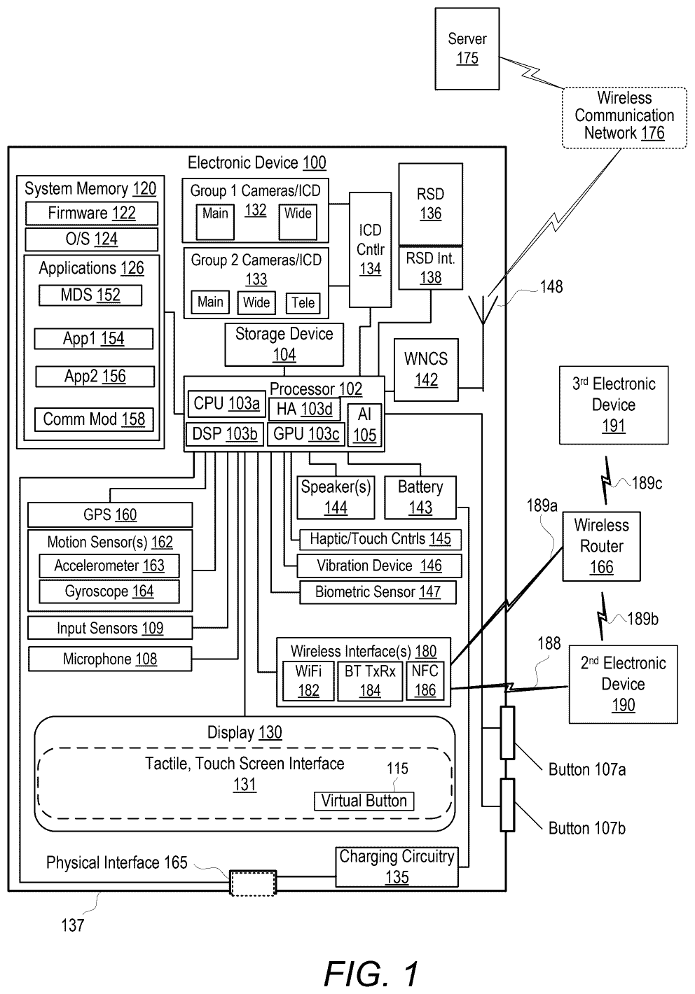

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable multi-device file storage management, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

For simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, multi-device storage (MDS) module 152, application 1 154, application 2 156, and communication module 158. Other applications may also be present. Descriptive names assigned to these modules add no functionality and are provided solely to identify the underlying features performed by processing the different modules. Each module and/or application provides program instructions/code that are processed by processor 102 to cause/configure processor 102 and/or other components of electronic device 100 to perform specific operations, as described herein. For example, multi-device storage (MDS) module 152 can include program instructions for implementing features of the disclosed embodiments. The multi-device storage (MDS) module 152 can include instructions that cause or configure processor 102 to detect a delete action for a file stored on the electronic device, query each of the at least one second electronic device 191 to determine if a copy of the file resides on one of the at least one second electronic device, and in response to determining that no copy of the file resides on any of the at least one second electronic device, render and present a warning message on the display, the warning message indicating that no additional copies of the file exist.

ICD controller 134 can perform image acquisition functions in response to commands received from processor 102 in order to control front ICDs 132 and back ICDs 133 to capture video or still images of a local scene within a FOV of the operating/active ICD. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133. In one or more embodiments, the functionality of ICD controller 134 is incorporated within processor 102, eliminating the need for a separate ICD controller.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program instructions/code and corresponding data, and RSD 136 can be interchangeably referred to as a non-transitory computer program product. RSD 136 may have a version of one or more applications stored thereon. Processor 102 can access RSD 136 to provision electronic device 100 with program instructions that, when executed/processed by processor 102, the program instructions cause or configure processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger or stylus on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. Other embodiments provide for multiple integrated displays within electronic device 100 and references to integrated display 130 are assumed to refer to one or all of these multiple integrated displays.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. In one or more embodiments, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera), which provides facial recognition for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless network communication subsystem (WNCS) 142, which can represent one or more front end devices (not shown) that are each coupled to one or more antennas 148. In one or more embodiments, WNCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, such as second electronic device 190 and/or third electronic device 191. via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WNCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, such as second electronic device 190, and/or third electronic device 191.

In one or more embodiments, electronic device 100 can communicate wirelessly with external wireless devices, such as a WiFi router 166, second electronic device 190, and/or third electronic device 191, via one or more of short-range wireless interface(s) 180. Electronic device 100 can wirelessly communicate with second electronic device 190 via communication signal 188 (communicating between wireless interface(s) 180 and second electronic device 190). Communication signal 189a and communication signal 189b provide an alternate communication path from electronic device 100 to second electronic device 190 through WiFi router 166. Similarly, communication signal 189a and communication signal 189c provide a communication path from electronic device 100 to third electronic device 191. In one or more embodiments, signals 188 and/or signals 189a-189c may be transmitted by short range communication device(s) within wireless interface(s) 180. Wireless interface(s) 180 can include short-range wireless communication adapters/transceivers, such as wireless fidelity (Wi-Fi) transceiver 182 for Wi-Fi connectivity, Bluetooth transceiver 184, and near field communication (NFC) transceiver 186. In one or more embodiments, electronic device 100 can receive Internet or Wi-Fi based calls, text messages, multimedia messages, and other notifications via wireless interface(s) 180. In one or more embodiments, WNCS 142 with antenna(s) 148 and wireless interface(s) 180 collectively provide/represent the wireless communications subsystem of electronic device 100.

Electronic device 100 of FIG. 1 is only a specific example of a device that can be used to implement the embodiments of the present disclosure.

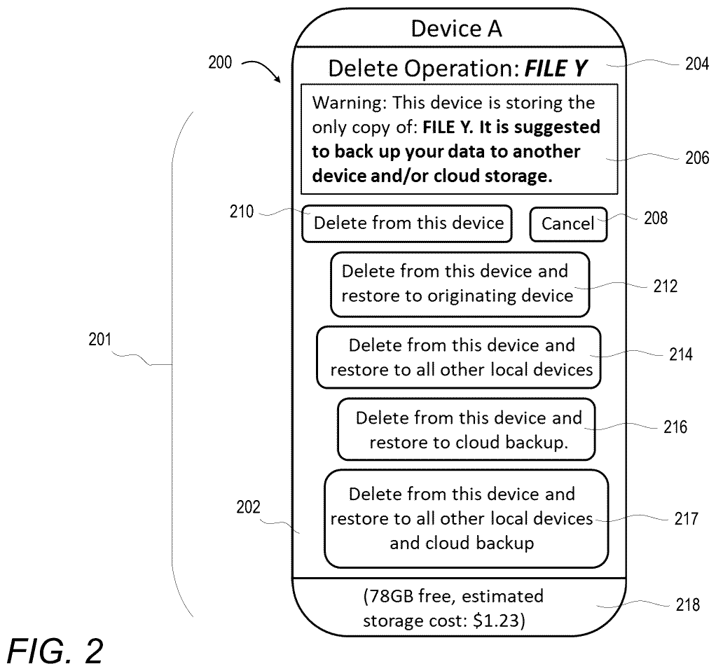

FIG. 2 is an example user interface rendered on an electronic device for multi-device file storage management, according to one or more embodiments. Electronic device 200 may be similar to device 100 depicted in FIG. 1. The user interface 201 for multi-device file storage management can be rendered on display 202. The user interface can include filename field 204, which can render a filename of a file that is selected for a delete operation. In one or more embodiments, additional file metadata may also be displayed, including, but not limited to, file size, creation date, last modification date, and/or other metadata associated with the file to be deleted. In the example of FIG. 2, the filename specified at filename field 204 is “FILE Y.” The user interface 201 can include a warning message 206. The warning message 206 can be presented in response to a determination that the file being deleted exists only on the electronic device 200. In one or more embodiments, the warning message 206 can include an indication that the file selected for deletion is the last copy stored across the multi-device storage environment (i.e., group of interconnected local devices). In one or more embodiments, warning message 206 can also include a suggestion, with selectable options, to store a copy of the file or move/transfer the file to a connected one of the at least one second electronic device or to upload the file to an available cloud storage system. The user interface can present one or more options. The user interface 2xy can include a cancel option 208. In response to detecting a selection of cancel option 208, the processor of the electronic device can abort the delete operation. The user interface 201 can include a delete from all devices option 210. In response to detecting selection of option 210, the processor of the electronic device can delete the file from electronic device 200, as well as also instructing any other devices within the multi-device system to delete copies of the file (FILE Y) that reside on those devices.

The user interface can include selectable option 212 to delete the file from all secondary devices but maintain a copy on the originating device. In response to detecting selection of option 212, the processor of the electronic device can copy the file to an originating device within the multi-device system, if the file does not currently exist on the originating device, and then delete the file from the other devices, including electronic device 200, where electronic device 200 is not the originating device. As an example, if FILE Y is an image file that was created by taking a photograph on a different electronic device than the device depicted in FIG. 2, and the FILE Y file currently only exists on device 200, then the processor of device 200 can transmit its copy of FILE Y back to the other device that initially created the file FILE Y with instructions that trigger local storage of the file copy on the other device, in the process of deleting (or removing) FILE Y from the electronic device 200.

The user interface can include an option 214 to delete from this device and restore to all other local devices. In response to detecting selection of option 214, the processor of the electronic device can transmit a copy of the file to all other devices within the multi-device system to trigger local storage at the other devices, and the processor can then delete the file from electronic device 200. The user interface can include an option 216 to delete from the device and move/store to a cloud backup. In response to detecting an invocation of option 216, the processor of the electronic device can copy/move the file to a cloud backup store, and delete the file from electronic device 200. In one or more embodiments, where the cloud account is not opened for access on the device, cloud account credentials can be entered a priori to enable seamless transferring of local files to the cloud backup store. Disclosed embodiments provide features that detect when a user is about to delete the only copy of a file (e.g., a photo on a smartphone), and provide options to back the file to other devices and/or cloud storage prior to deleting it. As an example usage scenario, prior to taking a vacation, a user may wish to delete files on his/her smartphone to increase available storage space to accommodate an increase in photos/videos that may be taken during the vacation. The user interface can include an option 217 to delete from this device and restore to all other local devices and to cloud backup. In response to detecting a press of option 217, the processor of the electronic device can perform steps associated with functionality associated with both option 214 and option 216 in a single user action.

The user interface can include cloud storage information field 218. In one or more embodiments, the cloud storage information field can include an estimated storage cost for the file that is currently being deleted from the electronic device 200. In one or more embodiments, the cloud storage information field can include an estimated amount of free space in the cloud backup store. Other information related to the cloud backup store may also be included in one or more embodiments. In one or more embodiments, the information displayed in field 218 may be obtained via application programing interface (API) calls to the cloud storage system. Some cloud storage systems may provide a direct API to query available space. In some cloud storage systems, the amount of available space may be determined by querying the number of files, number of blobs (Binary Large Objects), and/or number of bytes currently used, and subtracting that amount from a quota size, to determine the amount of available space. To determine the cost of storing a given file in cloud storage, one or more embodiments may scrape a pricing page for the given cloud system to determine a cost per megabyte, or other suitable unit, and then determine an estimated cost to store the file based on the size of the file and the cost per megabyte. One or more embodiments can include determining a file storage cost for the cloud storage system, and presenting the file storage cost with the warning message.

Some embodiments may include other file management options instead of, or in addition to, the options shown in FIG. 2. For example, one or more embodiments may include an option to copy a file to at least one other electronic device within the multi-device system prior to deleting the file from the source device. In one or more embodiments, the at least one other electronic device is selected randomly. In one or more embodiments, the at least one other electronic device is selected based on available storage space on the at least one other electronic device, a power/battery level of the at least one other electronic device, a network link quality for the at least one other electronic device, and/or other criteria. In one or more embodiments, the at least one other electronic device is selected based on a user-established hierarchy for storing files being deleted within the multi-device system. In one or more embodiments, the user-established hierarchy can be based on the type of file (e.g., document versus image or video or audio file). One or more embodiments can provide a user interface to enable deletion of the file on the electronic device. While the user interface depicted in FIG. 2 shows options implemented as buttons, one or more embodiments can include other user interface elements instead of, or in addition to, buttons. The other user interface elements can include, but are not limited to, checkboxes, radio buttons, dropdown list menus, and/or other suitable user interface elements.

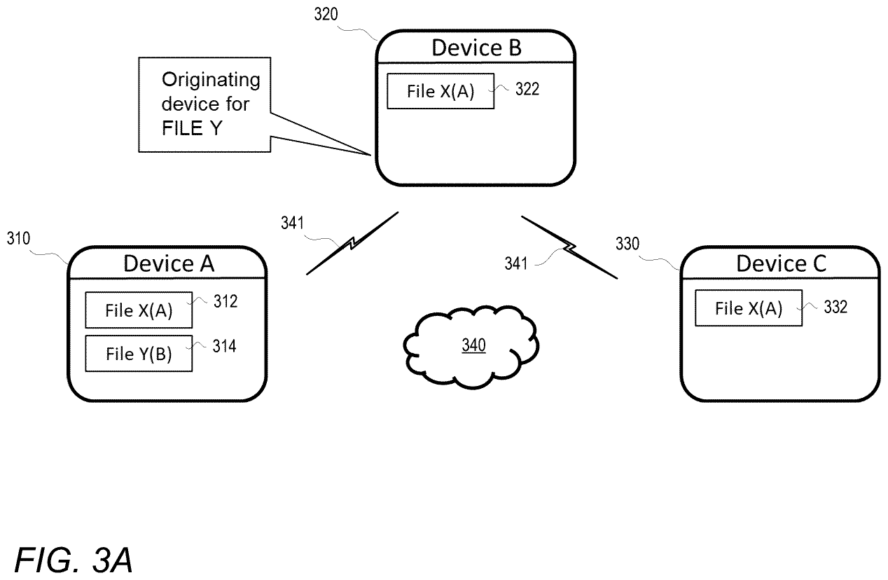

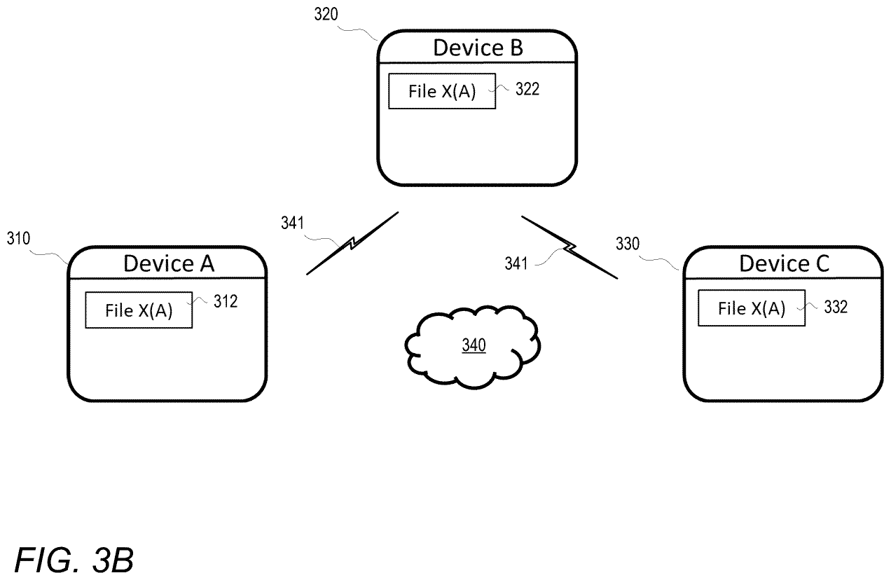

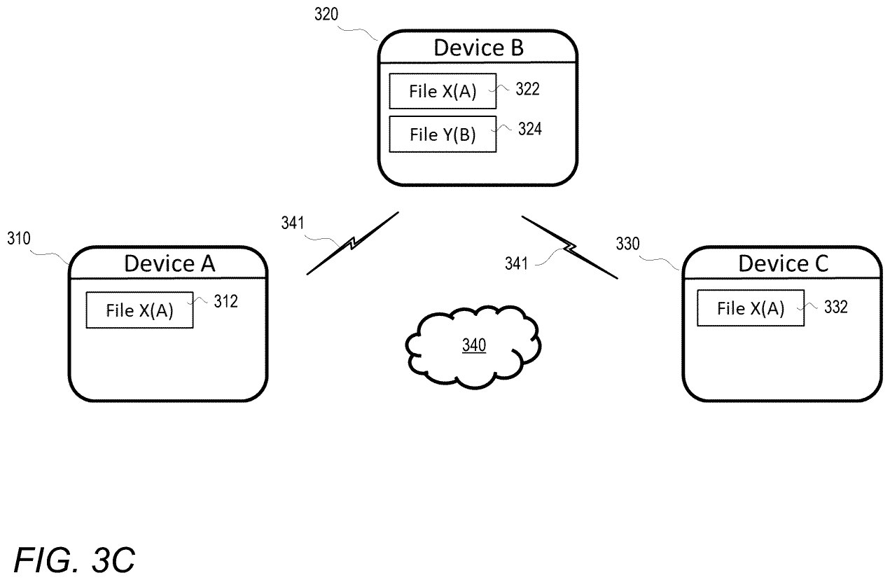

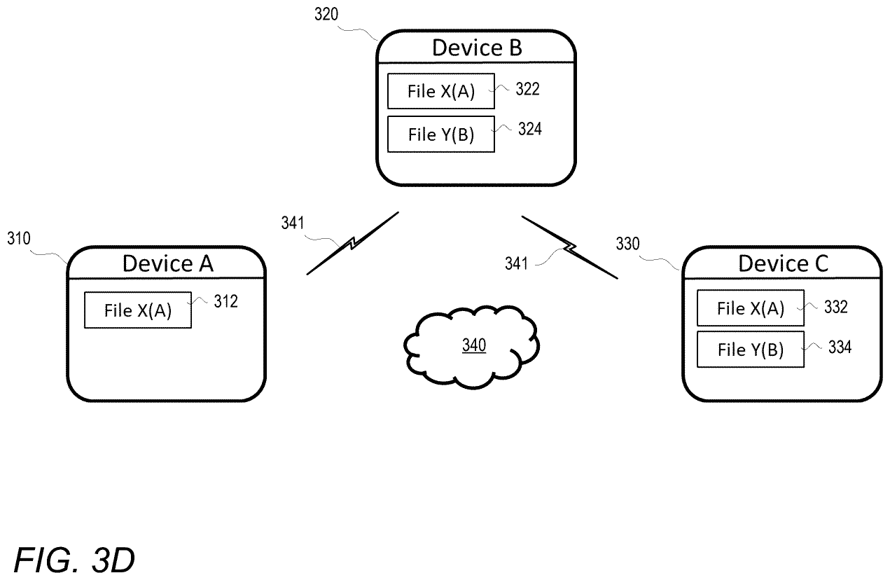

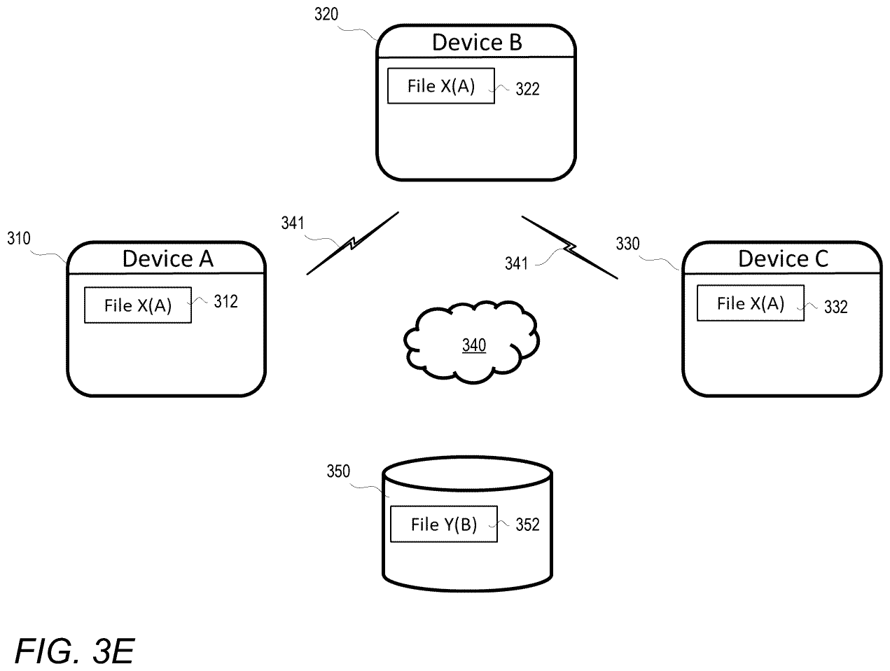

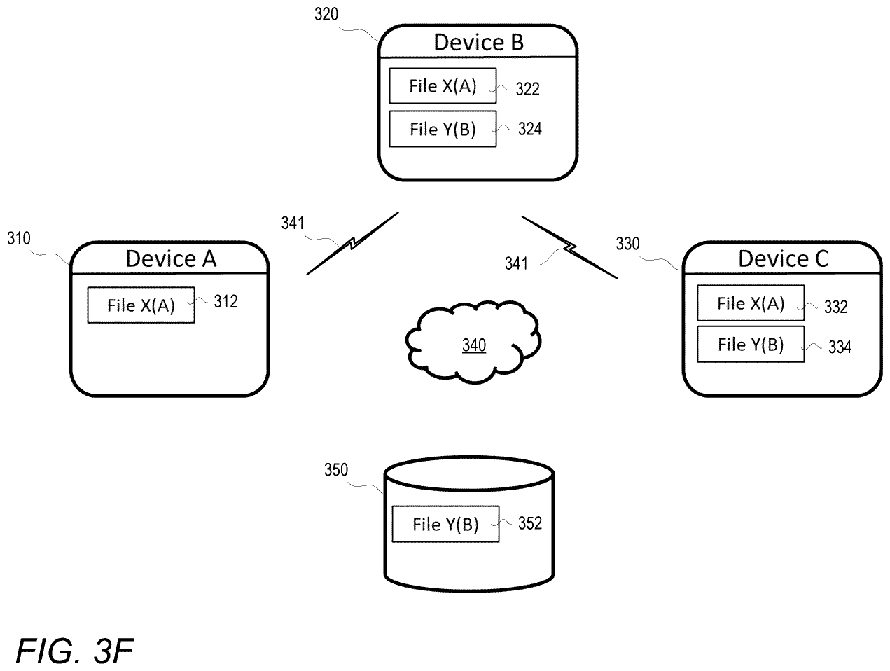

FIG. 3A illustrates starting conditions used for illustrating various examples of multi-device file storage management, according to one or more embodiments. As can be seen in FIG. 3A, the depicted multi-device system includes first device 310, second device 320, and third device 330, that are all interconnected (wired or wirelessly) within a multi-device system and are each able to transfer files between each other and store copies of a same file. The first device 310 may also be referred to as device A, the second device 320 may also be referred to as device B, and the third device 330 may also be referred to as device C. Each device 310, 320, 330 is shown currently storing one or more files. Each file is denoted in the format of name (origination source). Thus, file 312 on device A, indicated as X(A) means that file 312 has a file name of X and was created on (originated on) device A. Similarly, file 314 on device A has a file name of Y, and originated on device B. Thus, as indicated in FIG. 3A, device B is the originating device for file Y 314. Referring now to device 320 (device B), it can be seen that device B also is currently storing a copy of file X, indicated at 322. Similarly, device 330 (device C) is also currently storing a copy of file X, indicated at 332. Thus, the content of files 322 and 332 are identical to that of file 312. Each device within the multi-device system may have access to network 340, which can include a LAN, WAN, and/or Internet access. Additionally, devices 310, 320, and/or 330 may be interconnected via short-range communication links, indicated at 341. In one or more embodiments, the short-range communication links can be implemented via Bluetooth, Zigbee, Ultra-Wideband (UWB), infrared (IR), Z-wave, and/or other suitable protocols and/or standards. One or more embodiments can include: determining an origination electronic device for the file; in response to the origination electronic device being different from the electronic device: determining a connected status of the origination electronic device; and in response to determining that the origination electronic device is connected, transferring the file to a storage of the origination electronic device. One or more embodiments can include, in response to determining that the file is unavailable on the second electronic device, rendering and presenting a user interface message on the display, where the user interface message provides an option to create a backup copy of the file. It is appreciated that the file metadata includes an identification of the originating electronic device.

FIG. 3B illustrates an example of deleting a file from a device within a multi-device file storage management environment, based on the starting conditions indicated in FIG. 3A, that include one file that is copied on three devices, and another file that exists only on one device, according to one or more embodiments. Referring again to FIG. 2, user interface 201 on device A (corresponding to device 310) presents an option 210 to delete file Y from a device within the multi-device system. Referring again to FIG. 3A, it can be seen that only device A 310 has a copy of file Y. Referring again to FIG. 3B, the state of the multi-device system is shown after the operation provided by selecting option 210 of FIG. 2 has completed, where the file Y is removed from device 310. The removal of the file Y from the local device (device on which the delete operation was initiated) can be performed by the operating system of the local device. Thus, for device 310 (device A), when deleting the file Y by using the user interface on device A (depicted in FIG. 2), the operating system executing on device 310 removes the file. In one or more embodiments, to delete a file on another device, an API, remote procedure call (RPC), or other suitable technique may be used. In one or more embodiments, each device within the multi-device system has a RESTful API service running that allows file management operations. Accordingly, one or more embodiments may utilize RESTful APIs that support file management operations, such as an HTTP DELETE request to delete a file.

FIG. 3C illustrates the multi-device file storage management environment of FIG. 3A in which the file selected for deletion from the single first device is transferred to and stored within a file-originating device within the multiple device grouping, according to one or more embodiments. Referring again to FIG. 2, device A 310 has an option 212 to delete file Y from device A, and restore file Y to the originating device, device B 320. Referring again to FIG. 3A, file 314 (file Y) resides only on device A 310. Referring again to FIG. 3C, the state of the multi-device system is shown after the operation provided by selecting option 212 of FIG. 2 has completed, where the file Y is transferred to the originating device 320 (device B), as shown at 324, and removed from device 310 (device A). Thus, for device A 310, when deleting the file Y by selecting option 212 on the user interface on device A (depicted in FIG. 2), the operating system executing on device A 310 removes the file from its current directory location, and places the file in a temporary cache on the electronic device. In one or more embodiments, the temporary cache can be allocated in the system memory of the electronic device (e.g., system memory 120 of FIG. 1). A check may then be made to determine if a second device is currently connected to network 340, which can include a LAN, Bluetooth network, Zigbee network, or other suitable local network before starting the copy operation. In one or more embodiments, a determination of a connected status for a second electronic device can be performed by sending a message to the second electronic device and confirming receipt of a response. In one or more embodiments, ICMP (Internet Control Message Protocol) Echo Request and Echo Reply messages are used to test the reachability of another electronic device within the multi-device system/environment.

In one or more embodiments, to copy a file to another device, an API, remote procedure call (RPC), or other suitable technique may be used. In one or more embodiments, each device within the multi-device system has a RESTful API service running that allows file management operations. Accordingly, one or more embodiments may utilize RESTful APIs that support file management operations, such as an HTTP POST request to upload a file to another electronic device. One or more embodiments can include: copying the file to a temporary cache on the electronic device; determining a connected status of the second electronic device; and in response to determining that the second electronic device is connected to the electronic device, transferring the file to storage of the second electronic device. One or more embodiments can include: compressing the file to create a compressed file; copying the compressed file to a temporary cache on the electronic device; determining a connected status of the second electronic device; and in response to determining that the second electronic device is online, copying the compressed file to storage of the second electronic device.

FIG. 3D illustrates an example of transferring a file to all other local devices within a multi-device file storage management environment, based on the initial conditions indicated in FIG. 3A, according to one or more embodiments. The feature of transferring a file to all other local devices within a multi-device file storage management environment is useful when a particular file is of high importance for a user (e.g., an important photo). By transferring the file to multiple devices, an additional level of redundancy is achieved for safeguarding the important file. Referring again to FIG. 2, device A 310 has a selectable option 214, to delete file Y from device A, and restore file Y to all other local devices (devices within the multi-device system that are accessible to each other via a LAN), which includes device B (device 320) and device C (device 330). Referring again to FIG. 3A, file 314 (file Y) resides only on device A 310. Referring again to FIG. 3D, the state of the multi-device system is shown after the operation provided by selecting option 214 of FIG. 2 has completed, where the file Y is transferred to device B 320, as shown at 324, and device C 330 (device C), as shown at 334, and also removed from device A 310.

FIG. 3E illustrates an example of restoring a file to a cloud storage system, based on the initial conditions indicated in FIG. 3A, according to one or more embodiments. Referring again to FIG. 2, device A 310 has an option 216, to delete file Y from device A, and restore file Y to a cloud backup store. Referring again to FIG. 3A, it can be seen file 314 (file Y) resides only on device A 310. Referring again to FIG. 3E, it shows the state of the multi-device system after the operation provided by option 216 of FIG. 2 has completed, where the file Y is transferred to the cloud store 350, indicated as file 352, and the file (see 314 of FIG. 3A) is also removed from device A 310.

FIG. 3F illustrates an example of restoring a file to all other local devices within a multi-device file storage management environment and a cloud storage system, based on the initial conditions indicated in FIG. 3A, according to one or more embodiments. Referring again to FIG. 2, device A (corresponding to device 310) has an option provided by option 217, to delete file Y from device A, and restore file Y to all other local devices as well as a cloud backup store. Referring again to FIG. 3A, it can be seen file 314 (file Y) resides only on device 310 (device A). Referring again to FIG. 3F, it shows the state of the multi-device system after the operation provided by option 217 of FIG. 2 has completed, where the file Y is transferred to the device 320 (device B) as shown at 324, and device C 330, as shown at 334, and also transferred to the cloud store 350, indicated as file 352. Once the file is transferred to the cloud and other local devices, the file (see 314 of FIG. 3A) is removed from device A 310.

One or more embodiments can further integrate with cloud storage systems as well. In an example use case, files of high importance can be backed up to the cloud as well as the multiple devices, whereas other files may be backed up only to one or more device within the multi-device system. As no storage fees are associated with the multi-device system and the cloud storage system amy have limited storage bandwidth, a user can manage cloud storage costs by determining which files are backed up locally to the multi-device system, which files are backed up to a cloud storage system, and which files are backed up to both the multi-device system and a cloud storage system, enabling users to make informed decisions that align with their needs and circumstances for managing backup of their data. Thus, disclosed embodiments reduce the risk of inadvertently deleting the last remaining copy of a file, and also eliminate the need to spend excessive time manually cross-checking multiple devices to determine if a copy of a given file exists on another device when the file is selected for deletion on one device of the multi-device environment/system.

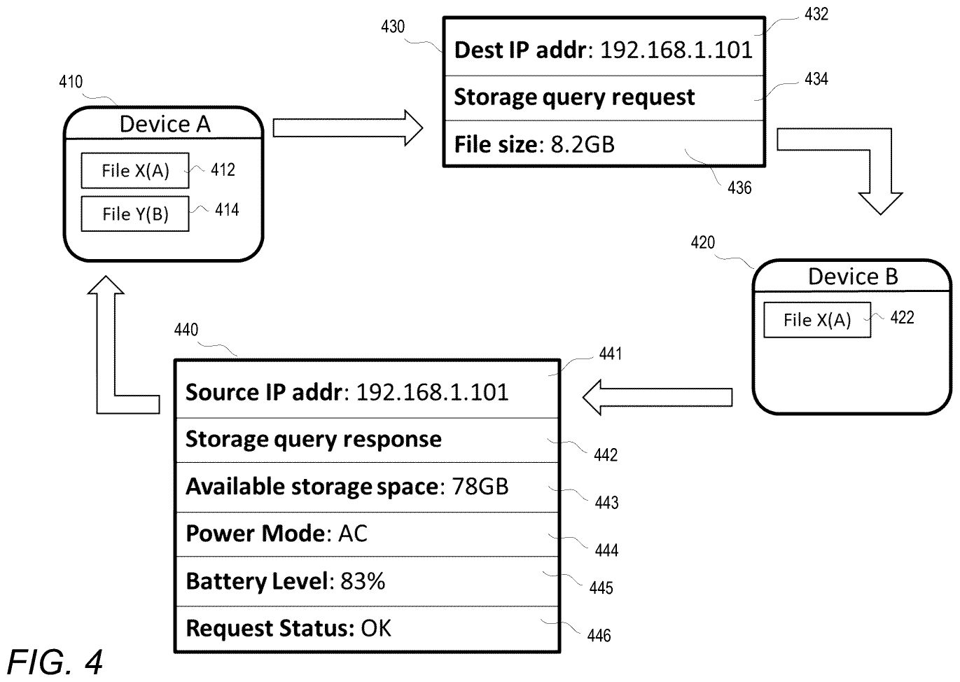

FIG. 4 illustrates exemplary data structures used for multi-device file storage management, according to one or more embodiments. In one or more embodiments, an electronic device can perform a storage query request and receive a storage query response, from one or more other electronic devices in a multi-device system. In embodiments, the multi-device system comprises multiple electronic devices interconnected via a direct wireless connection (e.g. Bluetooth) or via a local area network, and thus, the devices within the multi-device system may be referred to as local devices. As can be seen in FIG. 4, first electronic device 410 (device A) stores thereon two files, indicated as file 412 and file 414. A second electronic device 420 (device B) stores thereon one file, indicated as file 422. Referring again to file 412, the file is indicated as X(A), indicating that the file name is ‘X’ and that file X originated on device A. File 422 on second electronic device 420 is also indicated as X(A), and thus, file 422 is a copy of file 412.

In an example use case, a user may wish to delete file 414 from first electronic device 410. A common motivation for deleting a file is for freeing up more storage on the device to accommodate storage of new files. For example, a user may delete some files from his/her smartphone prior to going on vacation, so that the smartphone has more available storage for new photos acquired during the vacation. However, in some cases, the user may desire to store a copy of a deleted file on another device within the multi-device system, so that the file may be restored at a later time.

As can be seen in FIG. 4, file 414 is present on first electronic device 410, and is not present on second electronic device 420. In one or more embodiments, when a user initiates a delete operation for file 414, the first electronic device renders and presents a user interface similar to that shown in FIG. 2. Continuing with the example, the user may select option 214 from FIG. 2, to enable deleting the file 414 from the first electronic device 410 after storing a copy of the file to second electronic device 420. In one or more embodiments, prior to copying the file to second electronic device 420, the first electronic device 410 may issue a storage query request 430 to one or more other electronic devices within the multi-device system. In one or more embodiments, the storage query request 430 may be broadcast to all electronic devices within the multi-device system, multicast to a subset of electronic devices within the multi-device system, or unicast to a specific electronic device within the multi-device system. In one or more embodiments, the storage query request 430 includes a destination field 432, which can include an IP address, MAC address, and/or other suitable identifier(s) used for routing the storage query request. The storage query request 430 may further include a type field 434 that can include a string, enumeration, and/or alphanumeric code indicating a message or file type of storage query request. The storage query request 430 may further include a file size field 436. The file size field 436 can include a size in bytes, kilobytes, megabytes, gigabytes, or other suitable units. The size indicated in file size field 436 can be the file size of file 414. In this way, the storage query request 430 can be used to inform a potential recipient electronic device, such as second electronic device 420, about how much storage space is being requested.

In response to receiving the storage query request 430, the second electronic device 420 responds to the first electronic device with a storage query response 440. The storage query response 440 can include a source field 441. The source field 441 can include an IP address, MAC address, and/or other suitable identifier(s) used for identifying the source of the storage query response. The storage query response 440 may further include a type field 442 that can include a string, enumeration, and/or alphanumeric code indicating a message type of storage query response. The storage query response 440 may further include an available storage space field 443 that can include a size in bytes, kilobytes, megabytes, gigabytes, or other suitable units. The size indicated in available storage space field 443 can indicate an amount of available storage on second electronic device 420. In this way, the storage query response 440 can be used to inform other electronic devices within the multi-device network, such as first electronic device 410 about how much storage space is available on the second electronic device 420. In one or more embodiments, the amount of available space may be used by decision-making algorithms for determining which device(s) to use for file backup, and/or a prioritization scheme for determining which device(s) to attempt to use for file backup storage. For example, if one of the electronic devices within the multi-device network has 10 MB available space, and another one of the electronic devices within the multi-device network has 300 GB available space, then the prioritization can favor the electronic device that has 300 GB available, rather than the device that has 10 MB available. In one or more embodiments, when an electronic device reports an available space below a predetermined threshold (e.g., below 500 MB), then that device is omitted from being a recipient of file backup operations. That is, in one or more embodiments, the electronic device that has available space below a predetermined threshold (e.g., below 500 MB) is not used for file backup from other devices within the multi-device system. One or more embodiments can include: copying the file to a temporary cache on the electronic device; determining a connected status of the second electronic device; in response to determining that the second electronic device is online, determining an available free storage space on the second electronic device; in response to determining that the second electronic device has insufficient free storage space for storing the file, determining a connection status and an available free storage space of a third electronic device; and in response to determining that the third electronic device is connected and has sufficient free storage space, copying the file to storage of the third electronic device.

The storage query response 440 may further include a power mode field 444 that can indicate if the device that sent the storage query response is currently operating on AC power or battery power. The storage query response 440 may further include a battery level field 445 that can indicate a current charge level of a battery of the device that sent the storage query response. In one or more embodiments, the power mode and/or battery level information may be used for decision-making algorithms for determining which device(s) to use for file backup, and/or a prioritization scheme for determining which device(s) to attempt to use for file backup storage. For example, in one or more embodiments, if a particular electronic device within the multi-device system is currently operating on battery power, and the battery level is below a predetermined level (e.g., 25 percent), then that device may be omitted from being a recipient of file backup operations.

The storage query response 440 may further include a request status field 446 that can indicate if the storage query request 430 is accepted by the second electronic device 420. In one or more embodiments, the request status can include enumerated values representing statuses such as OK, INSUFFICIENT_SPACE, DEVICE_BUSY, LOW_POWER, POOR_NETWORK, and/or other relevant statuses. In one or more embodiments, in response to receiving a status of OK, the first electronic device 410 may then initiate a file transfer of file 414 to second electronic device 420. In response to receiving any status other than OK, the first electronic device 410 may then perform an alternative action sequence. The alternative action sequence can include displaying an error or warning message to a user, identifying one or more other devices within the multi-device system to use as backup sources, and/or using a cloud storage system for backup. In this way, disclosed embodiments can identify and rank multiple backup options for selection of a device or cloud storage for storing a file that is requested to be deleted from an electronic device, thereby simplifying the potentially daunting task of data management when deleting files to free up space on an electronic device.

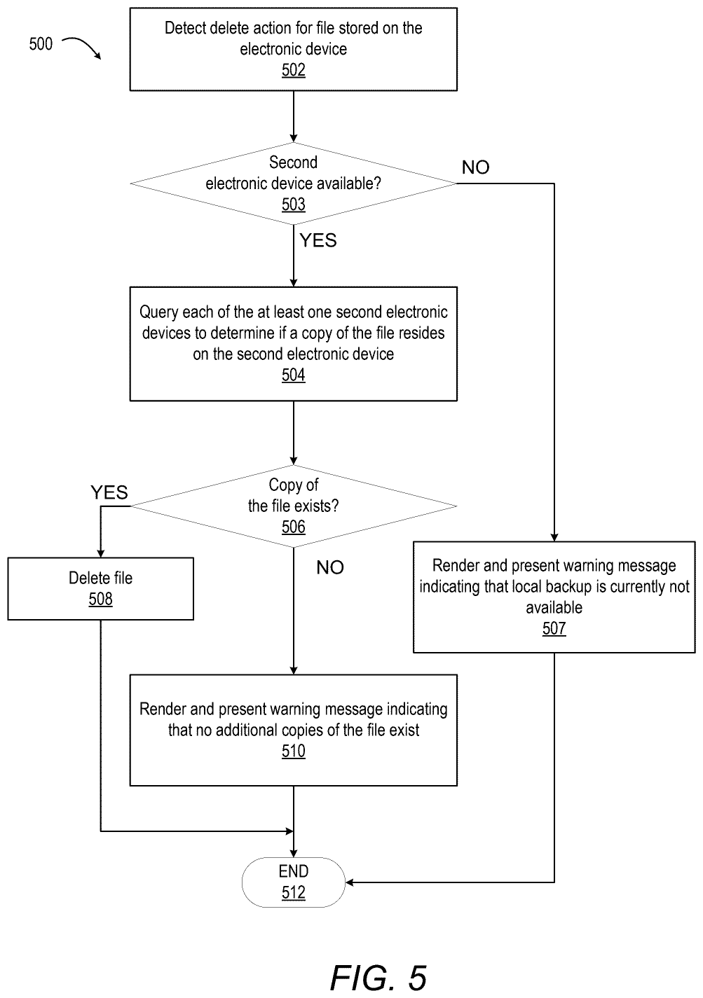

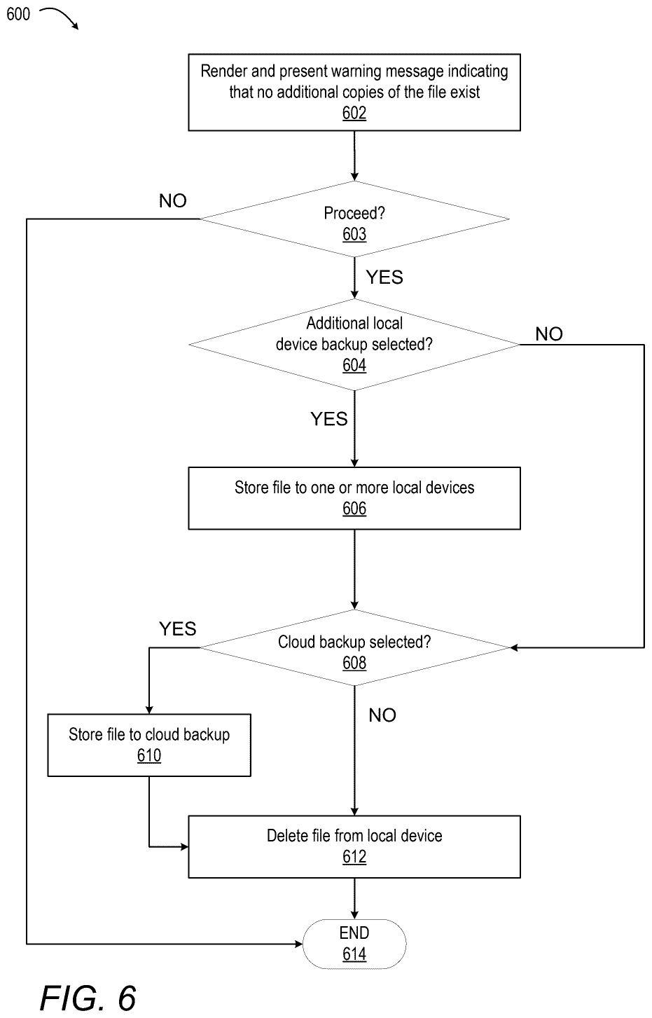

Referring now to the flowcharts presented by FIG. 5 and FIG. 6, the descriptions of the methods in FIG. 5 and FIG. 6 are provided with general reference to the specific components and features illustrated within the preceding FIGS. 1-4. Specific components referenced in the methods of by FIGS. 5-6 may be identical or similar to components of the same name used in describing preceding FIGS. 1-4. In one or more embodiments, processor 102 (FIG. 1) configures electronic device 100 (FIG. 1) to provide the described functionality of the methods of FIGS. 5-6 by executing program code for one or more modules or applications provided within system memory 120 of electronic device 100, including multi-device storage (MDS) module 152.

FIG. 5 depicts a flowchart of a computer-implemented method for multi-device file storage management, according to one or more embodiments. The method 500 starts at block 502, where a delete action for a file stored on the electronic device is detected. In one or more embodiments, the delete action can include swiping, tapping, double-tapping, or other suitable touchscreen operation. In one or more embodiments, the delete action can include double-clicking, right-clicking, or other suitable operation on a computer such as a laptop or desktop computer, followed by selection of a deletion option. The delete action can be grabbing/selecting and dragging a file to a trash icon. The method 500 continues to block 503, where a check is made to determine if at least one second electronic device is available. If, at block 503, it is determined that at least one second electronic device is available, then the method 500 continues to block 504, where a query of each of the devices within the multi-device system is performed to determine if a copy of the file resides on another device within the multi-device system. In one or more embodiments, each electronic device within the multi-device system has a RESTful API service running that allows directory listing operations, enabling any electronic device within the multi-device system to issue an HTTP GET request to retrieve a list of files (or confirmation of a single file) present on another electronic device within the multi-device system. Some embodiments may use SSH, RPCs, and/or other suitable techniques for performing directory listing operations and/or other file management operations.

The method 500 continues to block 506 where a check is made to determine if a copy of the file exists on another electronic device within the multi-device system. If, at block 506, it is determined that a copy of the file exists on another electronic device within the multi-device system, then the method 500 continues to block 508, where the file is deleted from the electronic device. In one or more embodiments, prior to deleting the file, a hash is performed on the file on the electronic device as well as the second electronic device. In one or more embodiments, the hash is an MD5 hash. Other hash techniques are possible in one or more embodiments. The hash from the file on the electronic device can be compared with the hash from the corresponding file on the second electronic device. If the hash values match, then the file on the second electronic device can be inferred to be an exact copy of the file on the electronic device, and the file can safely be deleted on the electronic device. In embodiments, if the hash values do not match, then the file on the second electronic device can be inferred to be nonidentical to the file on the electronic device, and in response to the mismatched hash values, the electronic device may perform additional actions, such as backing up the file on the electronic device to another electronic device, a cloud storage system, and/or issue a warning message regarding the nonidentical hash values of the file on the electronic device as compared with the same file on a second electronic device. In practice, a mismatch can occur if a user modifies a file on a particular electronic device within a multi-device system, and the changes have not been synced to other devices within the multi-device system. In one or more embodiments, a most recent version of the file is determined, and the most recent version is maintained within the multi-device system when a deletion is detected. Thus, if the file in the second electronic device is the most recent version of that file, the deletion operation may be allowed to proceed or a notification can be generated to inform the user that the current file is an older version of the file and does not match the most recent version. In such an implementation scenario, the notification would also permit the user to decide if to proceed with the deletion of the older version of the file. If, at block 506, it is determined that a copy of the file does not exist on any other electronic devices within the multi-device system, then the method continues to block 510, where a warning message such as shown at 206 in FIG. 2 is rendered and presented on the electronic device, indicating that no additional copies of the file exist. The method 500 then ends at block 512.

If, at decision block 503, it is determined that no second electronic device is currently available for receiving a copy of a file to be backed up, then the method 500 continues to block 507, where a warning message is rendered and presented, indicating that local backup is currently not available. In one or more embodiments, if no local devices are currently available (online), then a message may be presented on the electronic device to indicate that local device backup is not currently available. One or more embodiments may provide options to allow the user to delete the file (without backing the file to any local devices) and/or for backing up the file to a cloud storage system prior to deleting the file.

FIG. 6 depicts a flowchart of a computer-implemented method 600 for multi-device file storage management, with options for cloud storage, according to one or more embodiments. The method 600 starts with rendering and presenting a warning message indicating that no additional copies of the file exist and providing options for storing a copy of the file at another device or on a cloud backup, at block 602. The method 600 then continues to decision block 603 where a user is given an option to proceed with a delete operation or to cancel the delete operation. If, at decision block 603 a response is received to cancel the delete operation, the method 600 continues to block 614, where the method 600 ends. If, at decision block 603 a response is received to proceed with the delete operation, the method 600 continues to decision block 604 where a check is made to determine if one or more additional local backup devices are selected. If, at decision block 604, it is determined that additional local backup devices are not selected, then the method 600 continues to block 608 where a check is made to determine if determine if cloud backup is selected. If, at decision block 604, it is determined that one or more additional local (within the multi-device system) backup devices are selected, then the method 600 continues to block 606 where the file is stored to a selected one of the one or more additional local backup devices, and the method 600 then continues to block 608 where the check is made to determine if determine if cloud backup is selected. If, at decision block 608, it is determined that cloud backup is selected, then the method 600 continues to block 610 where the file is stored to a cloud backup system. If, at decision block 608, it is determined that cloud backup is not selected, then the method 600 continues to block 612 where the file is deleted from the local device. The method 600 then ends at block 614.

As can now be appreciated, disclosed embodiments provide techniques for multi-device file management that minimizes occurrences of inadvertent deletion of a final copy of a stored file. Disclosed embodiments enable multi-device storage on a network such as a Local Area Network (LAN) that offers several advantages, particularly in terms of data redundancy, cost savings, and control over data management. By distributing files across multiple connected devices and implementing the disclosed features, the file management system ensures that at least one copy of a file exists elsewhere before a file is deleted from a current device. This feature protects against data loss due to inadvertent deletion. Furthermore, if one device fails, the redundant storage of the file across multiple devices ensures data can still be accessed from another device, minimizing downtime and preventing data loss. In disclosed embodiments, if a user attempts to delete the only copy of a file within the multi-device system, the user is provided with alternative backup options prior to deleting the file, thereby preventing inadvertent data loss when deleting files in a multi-device system.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

1. An electronic device comprising:
at least one output device, including a display;
a communications subsystem, comprising at least one wireless interface for communicatively connecting with at least one second electronic device;
a memory having stored thereon a multi-device storage (MDS) module; and
at least one processor communicatively coupled to the display, the communications subsystem, and the memory, the at least one processor executing program code of the MDS module, and is configured to cause the electronic device to:
detect a delete action for a file stored on the electronic device;
query each of the at least one second electronic device to determine if a copy of the file resides on the second electronic device; and
in response to determining that no copy of the file resides on any of the at least one second electronic device, render and present a warning message on the display, the warning message indicating that no additional copies of the file exist.

2. The electronic device of claim 1, wherein further, the at least one processor is configured to:
copy the file to a temporary cache on the electronic device;
determine a connected status of the second electronic device; and
in response to determining that the second electronic device is connected to the electronic device, transfer the file to storage of the second electronic device.

3. The electronic device of claim 2, wherein further, the at least one processor is configured to provide a user interface to enable deletion of the file on the electronic device.

4. The electronic device of claim 2, wherein further, the at least one processor is configured to cause the electronic device to include, in the warning message, a suggestion to store the file to a connected one of the at least one second electronic device or upload the file to a cloud storage system.

5. The electronic device of claim 4, wherein further, the at least one processor is configured to cause the electronic device to:
determine a file storage cost for the cloud storage system; and
present the file storage cost with the warning message.

6. The electronic device of claim 1, wherein further, the at least one processor is configured to cause the electronic device to:
determine an origination electronic device for the file; and
in response to the origination electronic device being different from the electronic device:
determine a connected status of the origination electronic device; and
in response to determining that the origination electronic device is connected, transfer the file to a storage of the origination electronic device.

7. The electronic device of claim 1, wherein further, the at least one processor is configured to cause the electronic device to:
copy the file to a temporary cache on the electronic device;
determine a connected status of the second electronic device;
in response to determining that the second electronic device is online, determine an available free storage space on the second electronic device;
in response to determining that the second electronic device has insufficient free storage space for storing the file, determine an available free storage space of a third electronic device; and
in response to determining that the third electronic device is connected and has sufficient free storage space, copy the file to storage of the third electronic device.

8. The electronic device of claim 1, wherein further, the at least one processor is configured to cause the electronic device to:
compress the file to create a compressed file;
copy the compressed file to a temporary cache on the electronic device;
determine a connected status of the second electronic device; and
in response to determining that the second electronic device is online, copy the compressed file to storage of the second electronic device.

9. The electronic device of claim 1, wherein further, the at least one processor is configured to cause the electronic device to, in response to determining that the file is unavailable on the second electronic device, render a user interface message on the display, wherein the user interface message provides an option to create a backup copy of the file.

10. A method comprising:
detecting, on an electronic device including a display, and a communications subsystem, comprising at least one wireless interface for communicatively connecting with at least one second electronic device, a delete action for a file stored on the electronic device;
querying each of the at least one second electronic device to determine if a copy of the file resides on the second electronic device; and
in response to determining that no copy of the file resides on any of the at least one second electronic device, rendering and presenting a warning message on the display, the warning message indicating that no additional copies of the file exist.

11. The method of claim 10, further comprising:
copying the file to a temporary cache on the electronic device;
determining a connected status of the second electronic device; and
in response to determining that the second electronic device is connected to the electronic device, transferring the file to storage of the second electronic device.

12. The method of claim 11, further comprising providing a user interface to enable deletion of the file on the electronic device.

13. The method of claim 11, further comprising including, in the warning message, a suggestion to store the file to a connected one of the at least one second electronic device or upload the file to a cloud storage system.

14. The method of claim 13, further comprising:
determining a file storage cost for the cloud storage system; and
presenting the file storage cost with the warning message.

15. The method of claim 10, further comprising:
determining an origination electronic device for the file; and
in response to the origination electronic device being different from the electronic device:
determining a connected status of the origination electronic device; and
in response to determining that the origination electronic device is connected, transferring the file to a storage of the origination electronic device.

16. The method of claim 10, further comprising:
copying the file to a temporary cache on the electronic device;
determining a connected status of the second electronic device;
in response to determining that the second electronic device is online, determining an available free storage space on the second electronic device;
in response to determining that the second electronic device has insufficient free storage space for storing the file, determining an available free storage space of a third electronic device; and
in response to determining that the third electronic device is connected and has sufficient free storage space, copying the file to storage of the third electronic device.

17. The method of claim 10, further comprising:
compressing the file to create a compressed file;
copying the compressed file to a temporary cache on the electronic device;
determining a connected status of the second electronic device; and
in response to determining that the second electronic device is online, copying the compressed file to storage of the second electronic device.

18. The method of claim 10, further comprising, in response to determining that the file is unavailable on the second electronic device, rendering and presenting a user interface message on the display, wherein the user interface message provides an option to create a backup copy of the file.

19. A computer program product comprising a non-transitory computer readable medium having program instructions that when executed by a processor of an electronic device comprising a display and a communications subsystem that includes at least one wireless interface for communicatively connecting with at least one second electronic device, configure the electronic device to perform functions comprising:
detecting a delete action for a file stored on the electronic device;
querying each of the at least one second electronic device to determine if a copy of the file resides on the second electronic device; and
in response to determining that no copy of the file resides on any of the at least one second electronic device, rendering and presenting a warning message on the display, the warning message indicating that no additional copies of the file exist.

20. The computer program product of claim 19, further comprising program instructions for:
compressing the file to create a compressed file;
copying the compressed file to a temporary cache on the electronic device;
determining a connected status of the second electronic device; and
in response to determining that the second electronic device is online, copying the compressed file to storage of the second electronic device.
